(19) United States
(12) Patent Application Publication
(10) Pub. No.: US 2017/0011609 A1
(43) Pub. Date: Jan. 12, 2017

(54) Method and Apparatus for Detection of Hazardous Environmental Conditions and Initiation of Alarm Devices

(71) Applicant: United States of America, as represented by the Secretary of the Navy, Arlington, VA (US)

(72) Inventor: Phillip E. PACE, San Juan Bautista, CA (US)

(21) Appl. No.: 14/810,026

(22) Filed: Jul. 27, 2015

Related U.S. Application Data
(60) Provisional application No. 62/033,738, filed on Aug. 6, 2014.

(51) Int. Cl. G08B 21/02; G07C 5/08

(52) U.S. Cl. CPC G08B 21/02; G07C 5/08

(57) ABSTRACT

A method and apparatus for automatically determining a hazardous environmental condition within a container, such as a vehicle, and initiating alarm devices. In one embodiment, temperature, motion, acoustic, and pressure sensors in a vehicle output sensor signals to associated sensor threshold monitors. When a sensor threshold is exceeded, a sensor threshold monitor sends a threshold signal to a sensor collection logic device. The sensor collection logic device determines whether to initiate an alarm process based on whether the threshold signals indicated a hazardous environmental condition within the vehicle. In one embodiment, upon a determination to initiate the alarm process, the sensor collection logic device sends an alarm signal to an alarm processor which automatically initiates output signals to alarm devices, such as an audible alarm. In some embodiments, the output signals can further automatically unlock doors of the vehicle, retract windows of the vehicle, and automatically notify emergency personnel, such as police and emergency responders, of the location of the vehicle.

### CROSS-REFERENCE TO RELATED PATENT APPLICATIONS

This application is a non-provisional application of and claims priority to U.S. Patent Application 62/033,738, filed on Aug. 6, 2014, which is hereby incorporated by reference in its entirety.

### BACKGROUND OF THE INVENTION

1. Field of the Invention

The present invention relates generally to detection of hazardous environmental conditions and alarm systems as it pertains to the protection of living beings, for example humans and animals, which are enclosed within a container, such as a vehicle.

2. Description of the Related Art

In the prior art there are home alarm systems which can detect movement, smoke, certain gases, or entry through an alarmed access point and which can then activate an alarm and notify authorities. There are further in the prior art car alarm systems which can detect entry through an alarmed access point and activate a car horn and car lights.

### SUMMARY OF THE INVENTION

Embodiments in accordance with the invention include a method and apparatus for detection of hazardous environmental conditions within a container, such a vehicle, and automatic initiation of alarm devices.

In accordance with one embodiment, an apparatus to automatically detects hazardous environmental conditions within a container and initiate alarm devices includes: one or more sensors that detect environmental conditions within a container, each of the one or more sensors configured to output a sensor signal to an associated sensor threshold monitor; one or more sensor threshold monitors, each of the one or more sensor threshold monitors connected to an associated one of the one or more sensors, each of the one or more sensor threshold monitors for determining when an associated environmental condition exceeds an associated sensor threshold value and for sending an associated threshold signal to a sensor collection device; a sensor collection logic device connected to each of the one or more sensor threshold monitors, the sensor collection device configured to receive each threshold signal, the sensor collection device further for outputting an alarm signal to an alarm processor device when a hazardous environmental condition within the container is determined; and an alarm processor device connected to the sensor collection logic device, the alarm processor device for automatically generating and outputting one or more output signals to one or more associated alarm devices based on the alarm signal.

In accordance with one embodiment, a method to automatically detect hazardous environmental conditions within a container and initiate alarm devices includes: detecting one or more environmental conditions within a container at one or more sensors; outputting a sensor signal from each of the one or more sensors to one or more associated sensor threshold monitors based on the environmental conditions; receiving each of the sensor signals at one or more associated sensor threshold monitors; determining at each of the one or more associated sensor threshold monitors whether an associated sensor signal exceeds an associated predetermined sensor threshold level; upon a determination that a sensor signal exceeds an associated predetermined sensor threshold level, outputting a threshold signal from the associated sensor threshold monitor to a sensor collection logic device; receiving one or more threshold signals at the sensor collection logic device; determining whether to output an alarm signal to an alarm processor based on when the one or more threshold signals received at the sensor collection logic device indicate a hazardous environmental condition within the container; upon a determination to output an alarm signal, automatically outputting an alarm signal to the alarm processor; receiving the alarm signal at the alarm processor, and outputting one or more output signals to one or more alarm devices.

Embodiments in accordance with the invention are best understood by reference to the following detailed description when read in conjunction with the accompanying drawings.

### BRIEF DESCRIPTION OF THE DRAWINGS

FIG. 1 illustrates a drawing of an apparatus for the detection of hazardous environmental conditions and generation of alarm signals in accordance with one embodiment of the invention.

FIG. 2 illustrates a drawing of the sensor logic device of FIG. 1 in accordance with one embodiment of the invention.

FIG. 3 shown in partial views 3A and 3B illustrates a process flow diagram of a method for detection of hazardous environmental conditions and generation of alarm signals in accordance with one embodiment.

FIG. 4 illustrates a drawing of a vehicle including the apparatus of FIG. 1 in accordance with one embodiment.

Embodiments in accordance with the invention are further described herein with reference to the drawings.

### DETAILED DESCRIPTION OF THE INVENTION

Embodiments in accordance with the invention include a method and apparatus for detection of hazardous environmental condition within a container and initiation of alarm devices. In one embodiment, the method and apparatus can be used to detect a hazardous environmental condition within a container, such as a vehicle, and can mitigate the hazardous condition by generating and sending output signals to one or more alarm devices. In one embodiment, upon detection of a hazardous condition through sensors in the vehicle, an audible alarm is automatically sounded, such as a vehicle alarm, vehicle horn, or a dedicated audible alarm. In some embodiments, doors and/or windows of the vehicle are automatically unlocked and/or opened. In some embodiments a notification, which includes the location of the vehicle, is automatically generated and transmitted to authorities such as police and/or emergency personnel. In some embodiments, the location of the vehicle is obtained from a position location apparatus, such as global positioning system (GPS) connected with or part of the apparatus.

More particularly, embodiments in accordance with the invention have applicability in mitigating accidental deaths of occupants, such as children and animals, left unattended in vehicles, for example, such as when high temperatures create a hazardous situation within the vehicle.

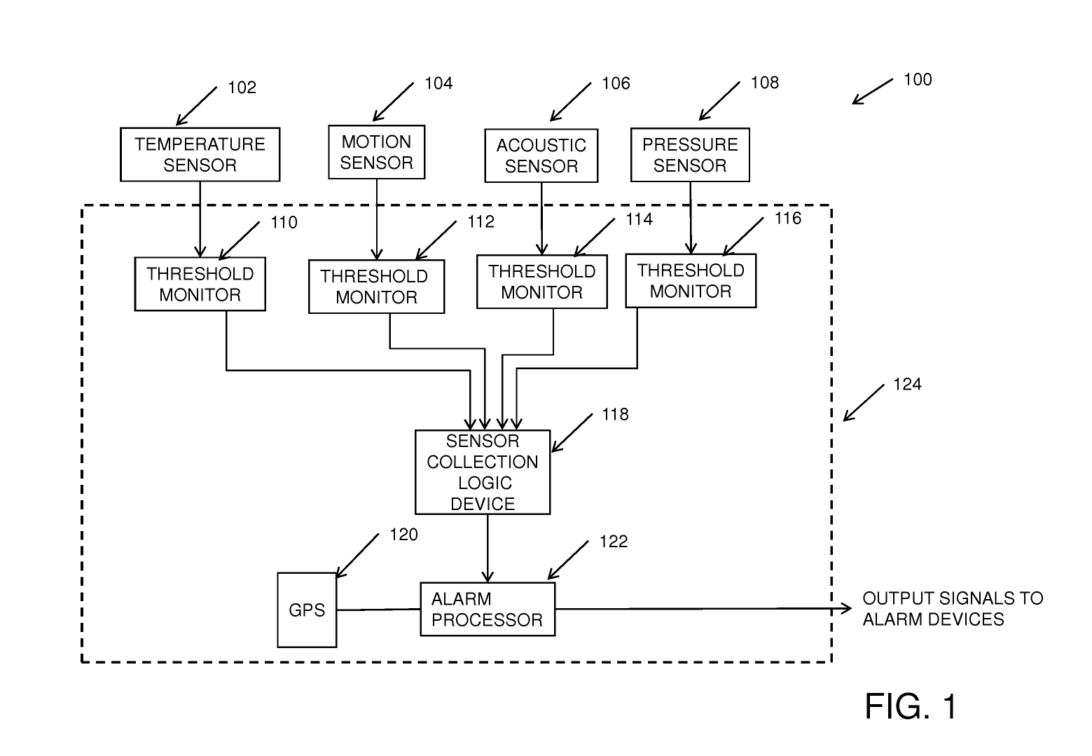

FIG. 1 illustrates a drawing of an apparatus 100 for the detection of a hazardous environmental condition and initiation of alarm devices in accordance with one embodiment of the invention. Embodiments in accordance with the invention include sensors, circuitry, and sensor processing to determine when a potentially environmentally hazardous condition is indicated within a contained space, such as a vehicle. Herein for purposes of illustration, the contained space is described as a vehicle. Referring now to FIG. 1, in one embodiment, apparatus 100 includes one or more sensors: a temperature sensor 102 which detects the temperature inside a vehicle; a movement sensor 104 which detects movement in a vehicle, such as movement of a child or animal within the vehicle; an acoustic sensor 106 which detects sound in the vehicle, such as talking, crying or barking within the vehicle; and a pressure sensor 108 which detect the presence of a human or animal within any one of the seats by their weight.

In one embodiment temperature sensor 102 detects a temperature inside the vehicle and sends the detected temperature to a sensor threshold monitor 1110. Sensor threshold monitor 1110 determines whether the detected temperature falls outside a predetermined critical temperature range. That is, a determination is made if the temperature has (a) exceeded a predetermined critical high-temperature threshold value, for example 75 degrees Fahrenheit or is (b) below a predetermined critical low-temperature threshold value, for example—32 degrees Fahrenheit. In one embodiment, if the detected temperature falls outside the predetermined temperature range, sensor threshold monitor 110 sends a signal, to a sensor collection logic device 118. In one embodiment sensor collection logic device 118 is a 4-input logic block.

In one embodiment motion sensor 104 detects motion inside the vehicle and sends the detected movement reading to a sensor threshold monitor 112. Sensor threshold monitor 112 determines whether the detected movement reading has exceeded a predetermined critical movement threshold value, for example 1 mm/s. In one embodiment, if the detected movement exceeds the critical movement threshold value, sensor threshold monitor 112 sends a signal, to sensor collection logic device 118.

In one embodiment acoustic sensor 106 detects an audible (20 to 20 kHz) sound level reading inside the vehicle and sends the detected sound level reading to a sensor threshold monitor 114. Sensor threshold monitor 114 determines whether the detected sound level has exceeded a predetermined critical sound threshold value, for example 10 SPL (Sound Pressure Levels) dB. In one embodiment, if the detected sound level exceeds the critical sound threshold value, sensor threshold monitor 114 sends a signal to sensor collection device 118. In one embodiment pressure sensor 108 detects the weight of each occupant seat and sends the detected weight readings to a sensor threshold monitor 116. Sensor threshold monitor 116 determines whether the weight reading exceeds the calibrated, zero-occupant weight tolerance value indicating the presence of a human or animal. In one embodiment, if the detected weight reading exceeds the zero-occupant weight tolerance value, sensor threshold monitor 116 sends a signal to sensor collection device 118.

As earlier described, the outputs of sensor threshold monitors 110, 112, 114, 116 are input to sensor collection logic device 118. In one embodiment, sensor collection logic device 118 is a logic block and logically combines the four threshold monitor inputs to generate (or not) a signal to an alarm processor 122. In one embodiment, if all four threshold monitor inputs are positive, i.e., a positive input indicating a sensor threshold was exceeded, sensor collection logic device 118, working as a logical AND, sends a signal to alarm processor 122 which then sends one or more output signals to predetermined alarm devices. For example, in one embodiment, alarm processor 122 can: send output signals to an audible alarm device, such as the vehicle horn device or the vehicle alarm device; send output signals to locking devices on the vehicle doors, causing the doors to unlock; generate and send an alarm broadcast notifying emergency responders, such as police, ambulance, or emergency systems, such as 911, of a hazardous situation. In one embodiment, alarm processor 122 obtains the location of the vehicle from a global positioning system (GPS) system 120 and includes the location of the vehicle in the alarm broadcast. In one embodiment a prerecorded message is also included in the alarm broadcast.

In one embodiment, sensors 102, 104, 106, 108 are located apart from but connected to sensor collection logic device 118. In one embodiment, one or more pressure sensor(s) 108 are located under each seat within the vehicle and the remaining components of apparatus 100, i.e., 110,112,114,116, 118, 120, 122, can be contained as a processing unit 124, shown by the dashed lines in FIG. 1. In one embodiment, GPS 120 is a component of apparatus 100 and contained in processing unit 124 and under battery power. In one embodiment, GPS 120 is included in apparatus 100 under battery power providing the position of the vehicle at all times even when the vehicle is off.

In various embodiments, greater fewer or different sensors may be utilized to detect particular hazardous conditions. Further in various embodiments, although sensors 102, 104, 106, 108 are shown separately from corresponding threshold monitors 110, 112, 114, 116, the sensor and corresponding threshold monitor may be combined as a single unit. Additionally, indications of positive and negative inputs can be made in accordance with various circuit and signal methodologies, such as specified voltage levels can be used to indicate positive and negative inputs.

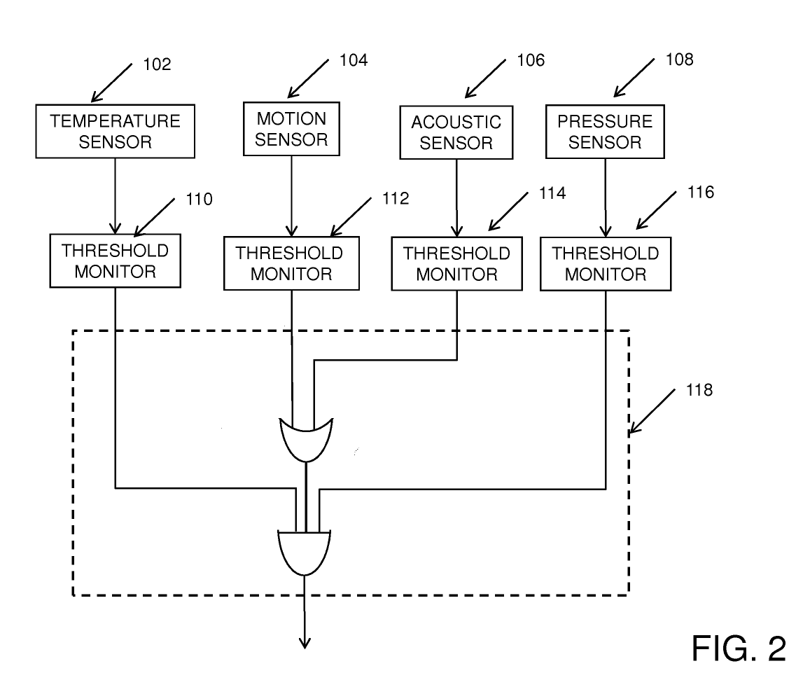

FIG. 2 illustrates a drawing of the sensor logic device of FIG. 1 in accordance with one embodiment of the invention. In one embodiment, sensor collection logic device 118 is formed as a logic block. In this embodiment, an alarm signal is sent from sensor collection logic device 118 to alarm processor 122 when either threshold monitor 112 or threshold monitor 114 or both threshold monitors 112, 114 output a positive signal (“YES”) and also when threshold monitors 108 and 113 both output a positive signal (“YES”). Although one exemplary logic configuration has been illustrated and described, it is not limiting on the invention, and other logic block embodiments configurations can also be used to determine whether an alarm signal is output to alarm processor 122 from sensor collection logic device 118 based on the inputs from threshold monitors 110, 112, 114, 116.

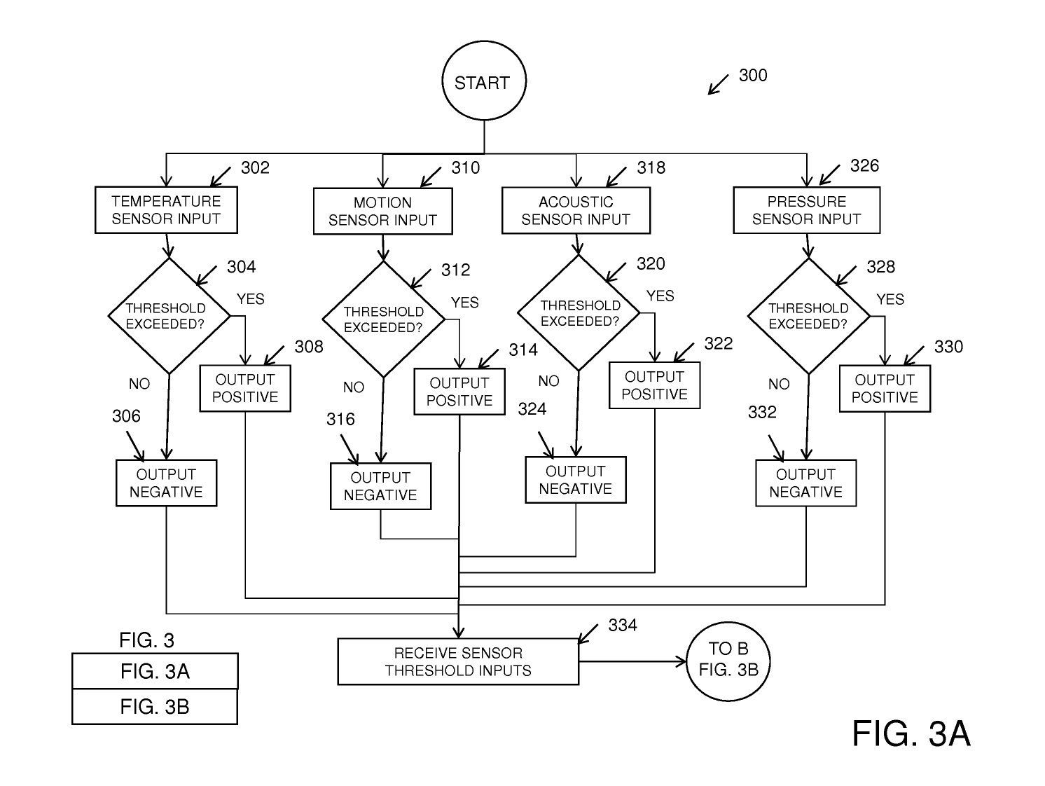

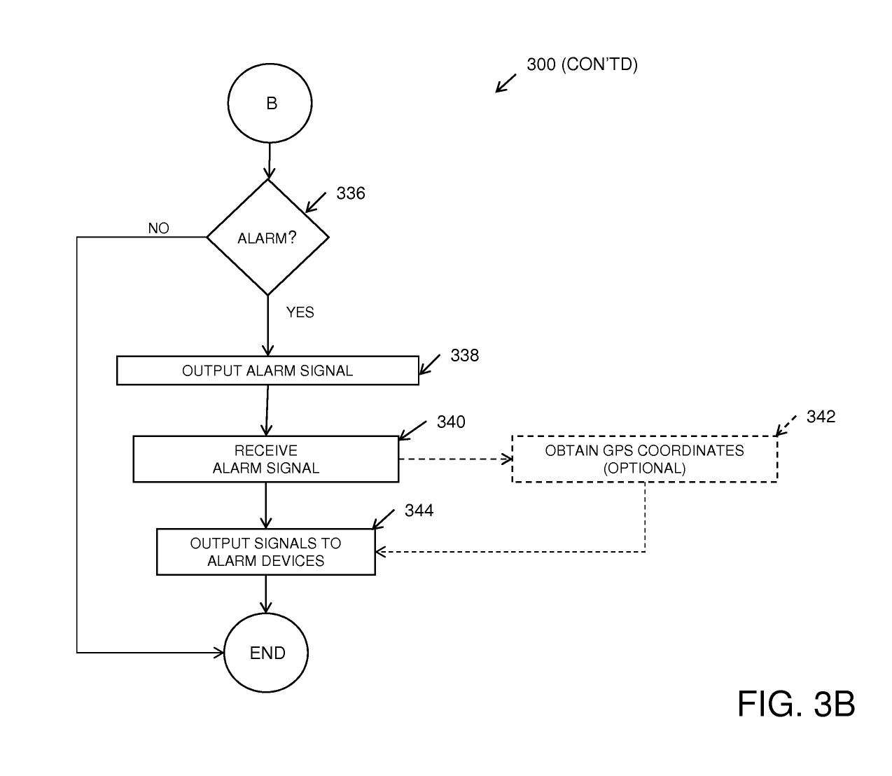

FIG. 3, shown together in partial views FIGS. 3A and 3B, illustrates a method 300 for detecting an environmentally hazardous condition and initiation of alarm devices in accordance with one embodiment of the invention. Referring now to FIGS. 1 and 3 together, in operation 302 a temperature inside a vehicle is detected, such as by temperature sensor 102. In operation 304 the detected temperature is sent to sensor threshold monitor 110 and a determination is made whether the temperature obtained in operation 302 exceeds a critical temperature threshold value. If the critical temperature threshold value is not exceeded (“NO”), in operation 306, a negative signal is sent to sensor collection logic device 118. Alternatively, if the critical temperature threshold value is exceeded (“YES”), in operation 308, a positive signal is sent to sensor collection logic device 118.

In operation 310 a movement reading is detected, such as by motion sensor 104. In operation 312 the detected movement reading is sent to sensor threshold monitor 112 and a determination is made whether the movement reading obtained in operation 310 exceeds a critical movement threshold value. In one embodiment, this determination is made by sensor threshold monitor 112. If the critical movement threshold value is not exceeded (“NO”), in operation 316, a negative signal is sent to sensor collection logic device 118. Alternatively, if the critical movement threshold value is exceeded (“YES”), in operation 314, a positive signal is sent to sensor collection logic device 118.

In operation 318 an acoustic reading (e.g., sound) is detected, such as by acoustic sensor 106. In operation 320 the detected acoustic reading is sent to sensor threshold monitor 114 and a determination is made whether the acoustic reading obtained in operation 318 exceeds a critical sound threshold value. In one embodiment, this determination is made by sensor threshold monitor 114. If the critical sound threshold value is not exceeded (“NO”), in operation 324, a negative signal is sent to sensor collection logic device 118. Alternatively, if the critical sound threshold value is exceeded (“YES”), in operation 322, a positive signal is sent to sensor collection logic device 118.

In operation 326 a pressure reading (e.g., weight) is detected, such as by pressure sensor 108. In operation 326 the detected weight reading is sent to sensor threshold monitor 116 and a determination is made whether the weight reading obtained in operation 326 exceeds a critical zero-occupant tolerance value. In one embodiment, this determination is made by sensor threshold monitor 116. If the critical weight threshold value is not exceeded (“NO”), in operation 332, a negative signal is sent to sensor collection logic device 118. Alternatively, if the critical weight threshold value is exceeded (“YES”), in operation 330, a positive signal is sent to sensor collection logic device 118.

In operation 334, the outputs of sensor threshold monitors 110, 112, 114, 116 are received as inputs at sensor collection logic device 118. In operation 336 a determination is made whether to send an alarm signal to alarm processor 122 based on the inputs from sensor threshold monitors 110, 112, 114, 116. In one embodiment, if positive inputs are received from all threshold monitors 110, 112, 114, 116 (“YES”), in operation 338, a hazardous environmental condition is assumed to exist within the vehicle, and sensor collection logic device 118 outputs an alarm signal to alarm processor 122. Alternatively, in one embodiment, if all negative input is received from threshold monitors 110, 112, 114, 116 (“NO”), sensor collection logic device 118 does not output an alarm signal to alarm processor 122 with method 300 ending.

In operation 340, alarm processor 122 receives the alarm signal from sensor collection logic device 118, and in operation 344 outputs signals to automatically activate one or more alarm devices as earlier described.

Optionally from operation 340, at operation 342, alarm processor 122 obtains GPS coordinates of the location of the vehicle for inclusion in one or more of the output signals of operation 344. In one embodiment, an output signal to a communication device, e.g., an alarm device, includes a prerecorded message, e.g., a notification, together with the GPS location of the vehicle.

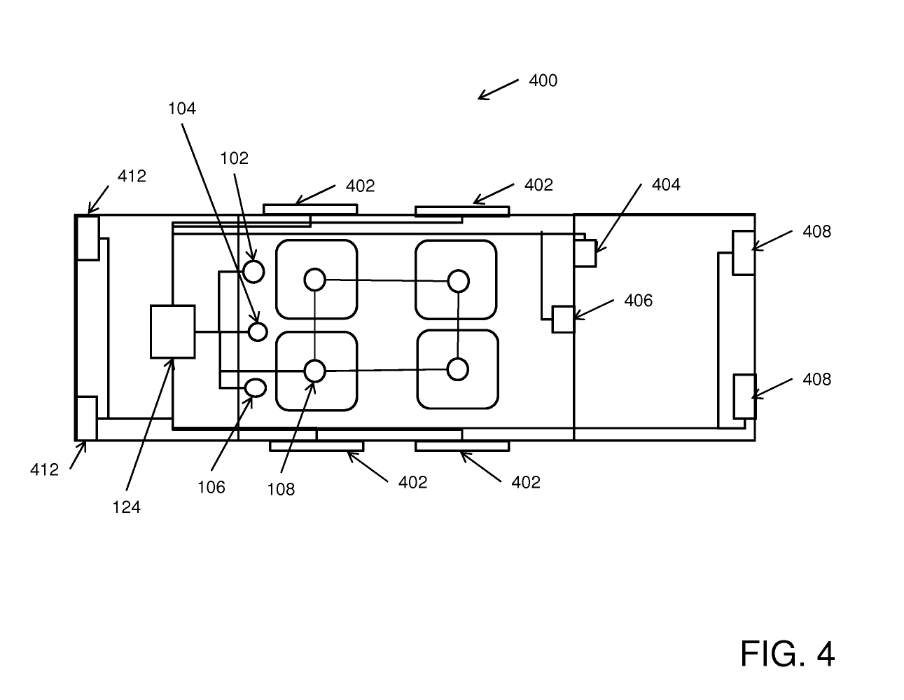

FIG. 4 shows one example of apparatus 100 installed in a vehicle in accordance with one embodiment of the invention. Referring now to FIGS. 1 and 4 together, a vehicle 400 includes apparatus 100 shown with sensors 102, 104, 106, 108 located at various locations within vehicle 400 and connected to processing unit 124. In one embodiment, a sensor 108 is located in each seat and connected either individually or collectively back to processing unit 124. Generally described, vehicle 400 includes one or more doors 402, one or more headlights 408, one or more tail lights 412, an audible horn 404, and a communication device 406. Although not shown, doors 402 include electronic devices for unlocking doors 402 and lowering windows of doors 402. In one embodiment, alarm processor 122 of processing unit 124 is connected through circuitry to allow alarm processor 122 to automatically send output signals to at least one of the alarm devices, such as audible horn 404, headlights 408, tail lights 412, communication device 406, and the electronic devices of doors 402 that allow for unlocking of doors 402 and lowering of windows of doors 402.

Embodiments in accordance with the invention allow for a hazardous condition to be automatically detected in a vehicle and one or more alarms to be automatically initiated. Embodiments in accordance with the invention have applicability in mitigating potentially hazardous conditions to occupants of vehicles by alerting authorities to a hazardous situation in progress and allowing for rescue of the occupants. In some embodiments, the windows can be automatically lowered and doors automatically unlocked.

This disclosure provides exemplary embodiments of the invention. The scope of the invention is not limited by these exemplary embodiments. Those of skill in the art can understand that embodiments in accordance with the invention can include more or less sensors and more, less, or different alarm devices. Further embodiments in accordance with the invention can be implemented in a variety of vehicles, and other contained spaces. Numerous variations, whether explicitly provided for by the specification or implied by the specification or not, may be implemented by one of skill in the art in view of this disclosure.

What is claimed is:

1. An apparatus to automatically detect hazardous environmental conditions within a container and initiate alarm devices comprising:
one or more sensors that detect environmental conditions within a container, each of said one or more sensors configured to output a sensor signal to an associated sensor threshold monitor;
one or more sensor threshold monitors, each of said one or more sensor threshold monitors connected to an associated one of said one or more sensors, each of said one or more sensor threshold monitors for determining when an associated environmental condition exceeds an associated sensor threshold value and for sending an associated threshold signal to a sensor collection device;
a sensor collection logic device connected to each of said one or more sensor threshold monitors, said sensor collection device configured to receive each said threshold signal, said sensor collection device further for outputting an alarm signal to an alarm processor device when a hazardous environmental condition within said container is determined; and
an alarm processor device connected to said sensor collection logic device, said alarm processor device for automatically generating and outputting one or more output signals to one or more associated alarm devices based on said alarm signal.

2. The apparatus of claim 1 wherein said one or more sensors comprise:
a temperature sensor for detecting temperature within said container;
a movement sensor for detecting movement within said container;
an acoustic sensor for detecting sound within said container; and
a pressure sensor, for detecting pressure at a location within said container.

3. The apparatus of claim 2 wherein said one or more sensor threshold monitors comprise:
a temperature sensor threshold monitor connected to said temperature sensor;
a movement sensor threshold monitor connected to said movement sensor;
an acoustic sensor threshold monitor connected to said acoustic sensor; and
a pressure sensor threshold monitor connected to said pressure sensor.

4. The apparatus of claim 1 wherein said sensor collection device is a four input AND gate device.

5. The apparatus of claim 1 wherein said alarm processor device is connected to at least one of a group consisting of an audible alarm mechanism, a door lock mechanism, a window retraction mechanism, a headlight mechanism, a communication device, and a tail light mechanism.

6. The apparatus of claim 5 wherein said alarm processor device is connected to a location position system.

7. The apparatus of claim 6 wherein said container is a vehicle.

8. A method to automatically detect hazardous environmental conditions within a container and initiate alarm devices comprising:
detecting one or more environmental conditions within a container at one or more sensors;
outputting a sensor signal from each of said one or more sensors to one or more associated sensor threshold monitors based on said environmental conditions;
receiving each of said sensor signals at said one or more associated sensor threshold monitors;
determining at each of said one or more associated sensor threshold monitors whether an associated sensor signal exceeds an associated predetermined sensor threshold level;
upon a determination that a sensor signal exceeds said associated predetermined sensor threshold level, outputting a threshold signal from said associated sensor threshold monitor to a sensor collection logic device;
receiving one or more threshold signals at said sensor collection logic device;
determining whether to output an alarm signal to an alarm processor based on when said one or more threshold signals received at said sensor collection logic device indicate a hazardous environmental condition within said container;
upon a determination to output an alarm signal, automatically outputting an alarm signal to said alarm processor;
receiving said alarm signal at said alarm processor; and
outputting one or more output signals to one or more alarm devices.

9. The method of claim 8 wherein said alarm processor automatically outputs one or more output signals to at least one of a group consisting of an audible alarm mechanism, a door lock mechanism, a window retraction mechanism, a headlight mechanism, a communication device, and a tail light mechanism.

10. The method of claim 9 wherein said alarm processor is connected to a location position system, and
further wherein said alarm processor obtains the location of said container from said location position system and automatically includes said location in one or more output signals to said communication system.

11. The method of claim 10 wherein said container is a vehicle.

12. The method of claim 11 wherein said receiving one or more threshold signals at said sensor collection device comprises:
receiving a temperature sensor threshold signal indicating a temperature above a threshold level within said container;
receiving a movement sensor threshold signal indicating movement within said container;
receiving an acoustic sensor threshold signal indicating sound within said container; and
receiving a pressure sensor threshold signal indicating pressure at a location within said container.

13. An apparatus comprising:
means for detecting one or more environmental conditions within a vehicle;
means for determining when said one or more of said environmental conditions pose a potentially hazardous condition within said vehicle;
means for determining whether to automatically initiate an alarm process based on a determination that said one or more of said environmental conditions pose a potentially hazardous condition; and
means for automatically initiating said alarm process when a determination is made to automatically initiate said alarm process.

14. The apparatus of claim 13 further comprising:
means for automatically obtaining a position location of said vehicle; and
means for automatically sending an emergency notification, said emergency notification comprising:
notification of a hazardous situation in said vehicle; and
said location of said vehicle.
